(19) United States
(12) Patent Application Publication
(10) Pub. No.: US 2014/0119463 A1
(43) Pub. Date: May 1, 2014

(54) Scalable Multifunction Serial Link Interface

(71) Applicant: TEXAS INSTRUMENTS INCORPORATED, Dallas, TX (US)

(72) Inventors: Yves Michel Marie Masse, Biot (FR); Eric Louis Pierre Badi, Cagnes sur Mer (FR); Christophe Denis Bernard Avoinne, Plano, TX (US)

(73) Assignee: Texas Instruments Incorporated, Dallas, TX (US)

(21) Appl. No.: 13/665,919

(22) Filed: Oct. 31, 2012

(30) Foreign Application Priority Data
Oct. 29, 2012 (EP) EP 12290373.5

(51) Int. Cl. H04L 27/00

(52) U.S. Cl. 375/259

(57) ABSTRACT

An integrated circuit includes two or more communication controllers and a plurality of point to point serial communication lanes for communication external to the integrated circuit. A programmable cross-point circuit allows different sets of serial communication lanes to be coupled at different times to the communication controllers in order to optimize performance of different applications.

### CLAIM OF PRIORITY UNDER 35 U.S.C. 119(a)

The present application claims priority to and incorporates by reference European Patent Application number, EP12290373.5, filed Oct. 29, 2012, entitled “Scalable Multifunction Serial Link Interface”.

### FIELD OF THE INVENTION

This invention generally relates to communication interfaces using multiple serial links, and in particular to the use of M-PHY for communication.

### BACKGROUND OF THE INVENTION

Mobile devices face increasing bandwidth demands for each of its functions as well as an increase of the number of functions integrated into the system. This requires wide bandwidth, low-pin count, and highly power-efficient interfaces that provides sufficient flexibility to be attractive for multiple applications, but which can also be covered with one physical layer technology.

The Mobile Industry Processor Interface (MIPI) Alliance has created standards for a number of mobile device interfaces. One critical component of any mobile device is the physical layer (PHY). The first PHY specification that the MIPI Alliance released in 2009 was the D-PHY. The D-PHY currently operates at rates up to 1 Gbps and supports both camera serial interface (CSI-2) and display serial interface (DSI), which are increasingly used in both feature and smart phones. M-PHY is the successor of D-PHY, requiring fewer pins and providing more bandwidth per pin pair with improved power efficiency. The M-PHY technology supports high-speed data rates starting at about 1000 Mbit/s. In addition to higher speeds, the M-PHY will use fewer signal wires because the clock signal is embedded with the data through the use of industry-standard 8b10b encoding. An M-PHY link capable of transmitting user data at 1000 Mbit/s is typically specified as being in 1250 Mbit/s mode due to the 8b10b encoding.

The Unified Protocol (UniPro), defined by the MIPI Alliance, defines a layered protocol for interconnecting devices and components within mobile device systems. It is applicable to a wide range of component types including application processors, co-processors and modems, as well as different types of data traffic including control messages, bulk data transfer, and packetized streaming. Implementing the UniPro specification reduces time-to-market and design costs by simplifying the interconnection of peripherals. In addition, the extensible nature of the specification simplifies new feature implementation. Versions 1.4 and beyond of UniPro support both the D-PHY as well as M-PHY technology. Target applications for UniPro include wireless handsets, tablets/netbooks, digital cameras, and multimedia devices. UniPro is optimized for mobile applications and scalable from a single link to full network.

The Low Latency Interface (LLI), defined by the MIPI Alliance, is a point-to-point interconnect that allows two devices on separate chips to communicate as if a device attached to the remote chip is resident on the local chip. The connection between devices is at their respective interconnect level, e.g. OCP (On Chip Bus), AMBA® (Advanced Microcontroller Bus Architecture) protocols, using memory mapped transactions. A LLI Link is a bidirectional interface allowing either device to initiate transactions. LLI primarily targets low-latency cache refill transactions. The low latency use cases are supported by the dedicated Low Latency traffic class (LL TC). The LLI specification is expressed as a layered, transaction level protocol, where Targets and Initiators on two linked chips exchange Transactions without software intervention. Software is used only to configure the LLI Link, for error handling and potentially, to initialize the LLI Stack. This configuration reduces latency and allows software compatibility regardless of the partitioning of the hardware on the two linked chips

### BRIEF DESCRIPTION OF THE DRAWINGS

Particular embodiments in accordance with the invention will now be described, by way of example only, and with reference to the accompanying drawings:

FIGS. 1 and 2 illustrate a prior art configuration of an M-PHY link;

FIGS. 3 and 4 are block diagrams illustrating a configurable M-PHY interface;

FIGS. 5-7 illustrate an example system with two integrated circuits coupled with configurable M-PHY links;

FIG. 8 is a flow chart illustrating operation of a configurable M-PHY interface; and

FIG. 9 is a block diagram illustrating a system with point to point serial interconnects.

Other features of the present embodiments will be apparent from the accompanying drawings and from the detailed description that follows.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

A mobile device, such as a smart phone or other type of digital assistant, may include several different integrated circuits that are interconnected. D-PHY or M-PHY serial links may be used in many applications to provide a high speed, low pin count interconnect between the various integrated circuits. Controller logic gets smaller as silicon geometry scales down; however, D-PHY and M-PHY physical interfaces are expansive in silicon and do not shrink easily with smaller silicon geometry, due to the requirements of the electrical or optic driver circuits. Typically, one or several D-PHY or M-PHY lanes are connected to each controller, such as LLI, Unipro, or CSI3. Together they provide a fixed functionality and fixed performance that is provided by the controller and the fixed number of lanes connected to each controller.

Embodiments of the invention allow a chip manufacturer to provide flexibility in the number of controller interfaces and in the performance of those interfaces. Embodiments of the invention allow a chip manufacturer to provide an implementation using minimum silicon area with minimum number of pins. As will be described in more detail below, embodiments of the invention provide a flexible interface that can connect, at configuration time, a set of controllers that provide a required functionality to a selected number of M-PHY Interface lanes in order to provide a required performance level. Configuration may be performed each time the system is powered on. In some embodiments, a reconfiguration may be performed during the course of operation to support a new or different application, such as a new software load, use of different protocols, etc. In this manner, a single version of an IC may be manufactured and then the serial communication lanes may be configured as needed for different system embodiments.

The following description will focus on the use of M-PHY lanes; however, another embodiment may provide a similar flexible interface that can provide similar benefits using a set of D-PHY lanes or other types of point to point serial lanes.

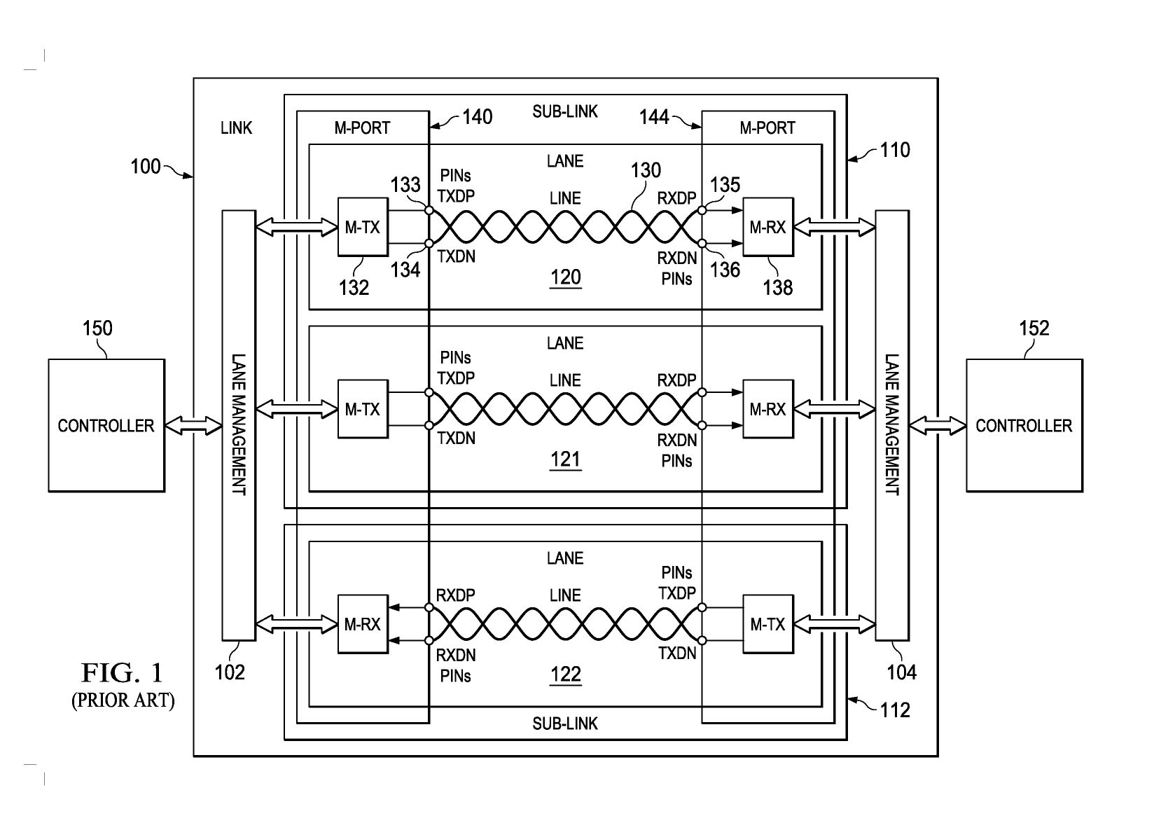

FIG. 1 illustrates a typical M-PHY link 100. M-PHY links provide a point to point interconnect between two nodes, such as nodes 150, 152. Each M-PHY link 100 includes a separate sublink 110, 112 for each direction of communication. Each sublink includes one or more lanes, such as lanes 120, 121 in sublink 110 and lane 122 in sublink 112. Each lane 120-122 is unidirectional and therefore data flows in only one direction on each lane. Each lane includes a transmitter (M-TX), as indicated at 132, and a receiver M-RX, as indicated at 138. Each transmitter M-TX includes a parallel to serial data converter and a physical line driver. Each receiver M-RX includes a physical line receiver and a serial to parallel data converter. Each transmitter M-TX and receiver M-RX is connected by a transmission line, as indicated at 130. Transmission line 130 may be a pair of wires that carry a differential electrical signal, or it may be a fiber optic link. In the case of a fiber optic link, there may be additional optic components to transmit into the fiber optic and to receive from the optic link.

At the end of each link 100 is a port. Port 140 includes two M-TX and one M-RX that are managed by lane management logic 102 and thereby coupled to controller 150. Similarly, port 144 includes one M-TX and two M-RX that are managed by lane management logic 104 and thereby coupled to controller 152. Lane management logic 102, 104 converts the unidirectional data flow on sublinks 110, 112 into bidirectional data flow for controllers 150, 152. Lane management logic 102, 104 also parses a flow of data from controller 150, for example, into two separate data sequences that are then transmitted via lanes 120 and 121 to lane management logic 104 which reassembles the parsed data stream and provides it to controller 152.

Each port includes physical drivers and receivers that are connected to the external pins of an integrated circuit that contains the port. For example, pins 133, 134 provide the connection points between differential line 130 and transmitter M-TX 132. Likewise, pins 135, 136 provide the connection points between differential line 130 and receiver M-RX 138.

The specific electrical characteristics and timing of link 100 are defined by the M-PHY standard available from the Mobile Industry Processor Interface (MIPI) Alliance. The operation of each M-PHY link is completely defined in the context of a protocol definition, such as LLI, DSI (digital serial interface), CSI (camera serial interface), UniPro, or DigRF (digital RF) which may be used by a controller that is managing the lane, as defined in respective MIPI Alliance standards.

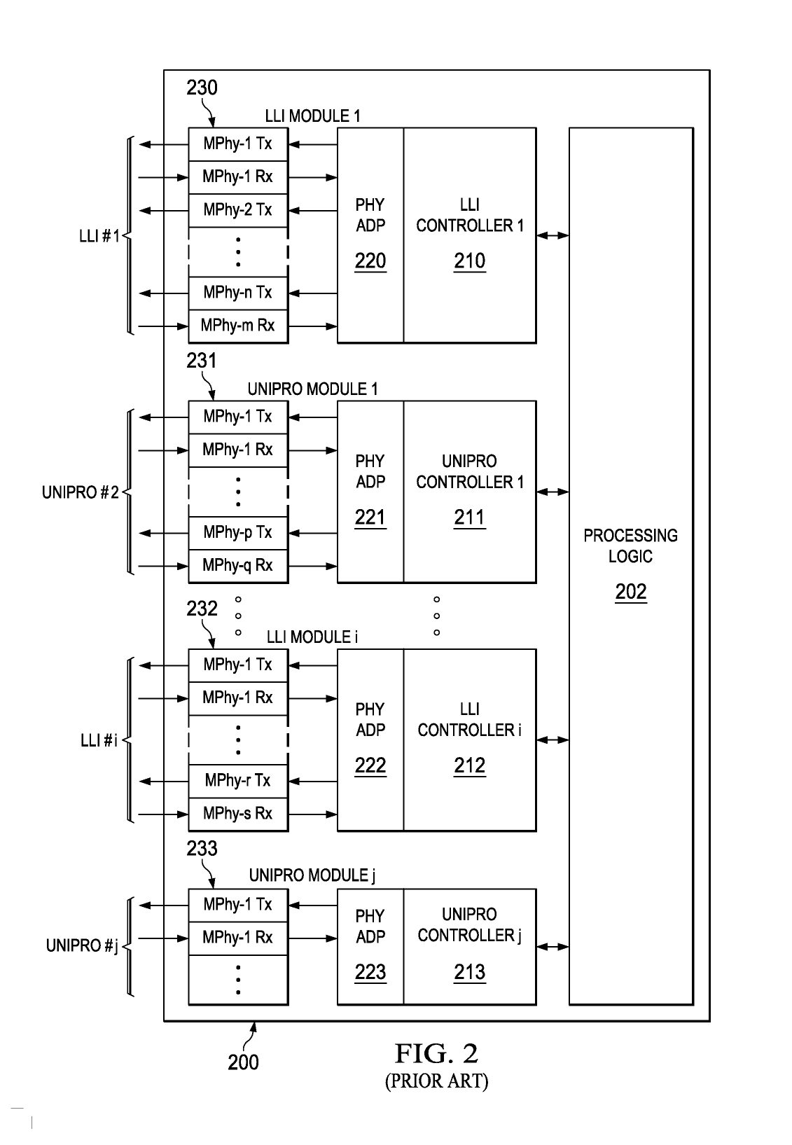

FIG. 2 is a block diagram illustrating a typical prior art configuration of multiple M-PHY controllers in a single integrated circuit 200. In the prior art, the configuration of controllers and M-PHY lanes is determined when an integrated circuit is designed and the integrated circuit is then implemented with the predetermined fixed configuration. In this example, controller 210 is a Low Latency Interface (LLI) controller, and controller 211 is a Unified Protocol (UniPro) controller. There may be additional LLI and UniPro controllers, as indicated at 212, 213. Each controller 210-213 is connected to a respective defined set of M-PHY lanes. For example, LLI controller 210 is connected to a set of M-PHY lanes 230 that includes n transmit lanes and m receive lanes. Similarly, UniPro controller 211 is connected to a defined set of M-PHY lanes 231 that includes p transmit lanes and q receive lanes, LLI controller 212 is connected to a defined set of M-PHY lanes 232 that includes r transmit lanes and s receive lanes, and UniPro controller 213 is connected to a set of M-PHY lanes 233 that includes defined set of transmit lanes and receive lanes. All of the controllers are coupled to other processing logic 202 within integrated circuit 200. Processing logic 202 may include one or more central processing units, for example.

Each controller 210-213 includes a respective physical adaptor 220-223. Each physical adaptor, such as physical adaptor 220 connected to LLI controller 210, is implemented when the integrated circuit is designed to parse transmitted traffic from controller 210 onto each of the transmit lanes MPHY-1 TX through MPHY-n TX and to merge all traffic received via receive lanes MPHY-1 RX through MPHY-m RX to provide a single received stream to controller 210. In this example, the parsing and merging operation of the physical adaptors is performed according to a relevant MIPI standard for each controller type.

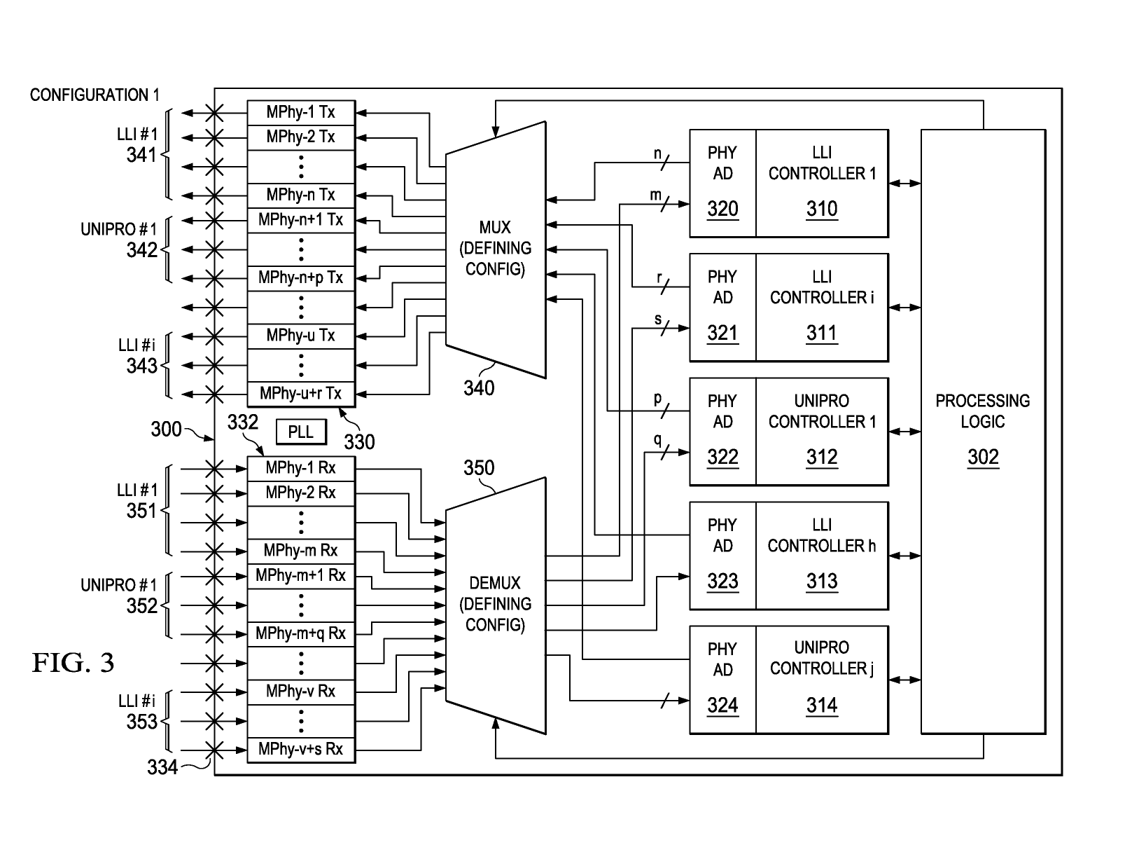

FIGS. 3 is a block diagram illustrating an embodiment of the present invention that includes multiple M-PHY controllers in a single integrated circuit (IC) 300 in which the M-PHY interface is configurable. In this example, five M-PHY controllers 310-314 coupled to processing logic 301 are illustrated; however, in other embodiments, more or fewer controllers may be included. Processing logic 302 may include one or more central processing units (CPU) along with memory, caches, and various peripheral device circuits, for example.

Each physical adaptor 320-324 is implemented to support a number of M-PHY lanes, which will be referred to as the maximum number of lanes for a particular controller. For example, physical adaptor 320 may support a maximum number of twelve M-PHY lanes for LLI controller 310, while adaptor 322 may only support a maximum number of four M-PHY lanes for UniPro controller 312. The physical adaptors of FIG. 3 provide the function similar to the lane manager of FIG. 2, such as lane manager 102 or 104.

A pool of M-PHY transmit lane ports 330 and a pool of M-PHY receive lane ports 332 are implemented. Each of the transmit lane ports in pool 330 and receive lane ports in pool 350 are coupled to pins 334 of integrated circuit 300 to provide an interface to other integrated circuits. In FIG. 3, driver and receiver logic, such as discussed with regard to M-PORT 140, 142 of FIG. 2, is included within the pool of M-PHY transmit laneports 330 and the pool of M-PHY receive lane ports 332

A multiplexor 340 and a demultiplexor 350 provide a flexible interconnect between the physical adaptors 320-324 of each of the controllers 310-314 and the interface pins 334 of IC 300. Inputs of a multiplexor 340 are coupled to all of the transmit lane terminals from all of physical adaptors 320-324. Outputs from multiplexor 340 are coupled to all of the transmit lane ports in M-PHY transmit lane pool 330. Similarly, inputs of a demultiplexor 350 are coupled to all of the receive lane ports in M-PHY receive lane pool 332. Outputs from demultiplexor 350 are coupled to all of the receive lane terminals for all of physical adaptors 320-324.

Multiplexor 340 and demultiplexor 350 may be configured to couple various numbers of transmit lanes in pool 330 and receive lanes in pool 350 to each of controllers 310-314. The number of transmit lanes and receive lanes coupled to a controller may be different. Configuration of multiplexor 340 and demultiplexor 350 may be performed by software executed on a CPU in processing logic 302 each time IC 300 is powered on. Additionally, in some embodiments, configuration of multiplexor 340 and demultiplexor 350 may be performed by software executed on a CPU in processing logic 302 when a new application program is initiated by processing logic 302, for example.

In some embodiments, multiplexor 340 and demultiplexor 350 may function as a complete cross-point switch and allow any transmit lane port to be coupled to any physical adaptor transmit lane terminal and allow receive lane port to be coupled to any physical adaptor receive lane terminal. In other embodiments, timing restrictions may limit the cross-point interconnect capability to a subset of all possible connections.

In some embodiments, configuration of multiplexor 340 and demultiplexor 350 may be performed by software executed on a CPU in processing logic 302 to optimize performance of one or more application programs being executed by processing logic 302, for example. For example, if an application is being executed that uses LLI controller 310 heavily, but uses LLI controller 311 only lightly, or not at all, extra lanes may be allocated to LLI controller 310 and taken away from LLI controller 311. When a second application begins executing that may use LLI controller 311 more heavily, lanes may be reshuffled again to optimize the performance of the second application.

In this manner, rather than implementing a maximum number of M-PHY lane ports for all of the controllers 310-314, as done in prior art, a reduced set of M-PHY lanes may be implemented in transmit lane pool 330 and receive lane pool 332 and be configured as needed depending on what application is being performed by IC 300. When IC 300 is designed, the size of M-PHY transmit lane pool 330 and M-PHY receive lane pool 332 may be selected based on an amount of real estate available on the chip, for example.

FIG. 3 illustrates configuration 1, which is an example configuration. In configuration 1, multiplexor 340 is configured by software to couple a number n transmit lane ports 341 to LLI controller 310, a number p transmit lane ports 341 to UniPro controller 312, and a number r transmit lane ports 343 to LLI controller 311. n is less than or equal to the maximum number of transmit lanes that physical adaptor 320 can support. p is less than or equal to the maximum number of transmit lanes that physical adaptor 322 can support. r is less than or equal to the maximum number of transmit lanes that physical adaptor 321 can support.

Demultiplexor 350 is configured by software to couple a number m receive lane ports 351 to LLI controller 310, a number q receive lane ports 352 to UniPro controller 312, and a number s receive lane ports 353 to LLI controller 311. m is less than or equal to the maximum number of receive lanes that physical adaptor 320 can support. q is less than or equal to the maximum number of receive lanes that physical adaptor 322 can support. s is less than or equal to the maximum number of receive lanes that physical adaptor 321 can support.

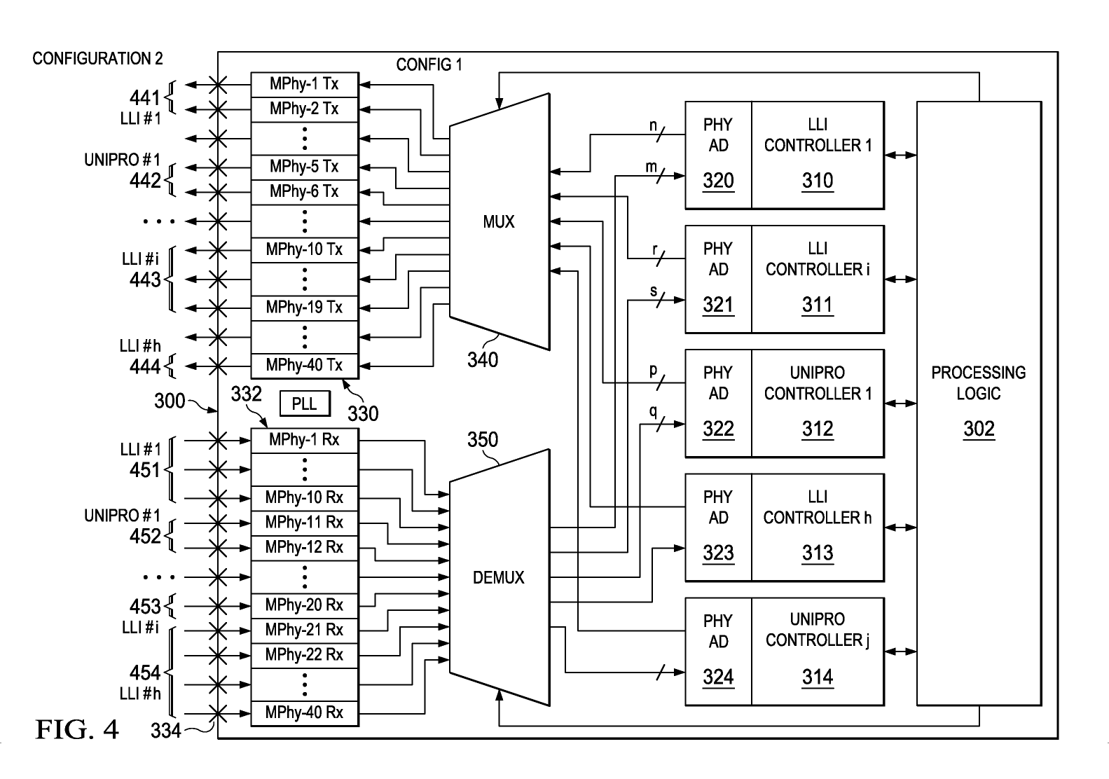

FIG. 4 illustrates configuration 2, which is another example configuration of IC 300 from FIG. 3. In this example, it is assumed that the size of M-PHY transmit lane pool 330 and M-PHY receive lane pool 332 is 40 lanes each, for example; however, as mentioned above, when IC 300 is designed the size of M-PHY transmit lane pool 330 and M-PHY receive lane pool 332 may be adjusted based on an amount of real estate available on the chip, for example. It is also assumed that LLI controllers can support up to a maximum of twelve lanes and that UniPro controllers can support up to a maximum of four lanes, however, in other embodiments these assumptions may be different. While two configurations are illustrated in FIGS. 3-4, there is no limit to the number of configurations that may be created by programming multiplexor 340 and demultiplexor 350.

In example configuration 2, multiplexor 340 is configured by software to couple two transmit lanes 441 to LLI controller 310, two transmit lanes 441 to UniPro controller 312, ten transmit lanes 443 to LLI controller 311, and one transmit lane 444 to LLI controller 313, for example.

Demultiplexor 350 is configured by software to couple ten receive lanes 451 to LLI controller 310, two receive lanes 452 to UniPro controller 312, one receive lane 453 to LLI controller 311, and ten receive lanes 454 to LLI controller 313, for example.

Note that in some configurations, some of the controllers or some of the M-PHY lanes may be used.

In this example, multiplexor 340 may be implemented as forty individual multiplexors, where each of the forty multiplexors is connected to one of the M-PHY TX lane ports in transmit pool 330. Each of the forty multiplexors may be configured to select any M-PHY transmit lane from any one of the physical adaptors 320-324, as described above. Similarly, demultiplexor 350 may be implemented as forty individual demultiplexors, where each of the forty demultiplexors is connected to one of the M-PHY RX lane ports in receive pool 332. Each of the forty demultiplexors may be configured to select any M-PHY receive lane from any one of the physical adaptors 320-324, as described above. Other embodiments may implement multiplexor 340 and demultiplexor 350 using multiplexor/demultiplexor or cross bar technology now known or later developed.

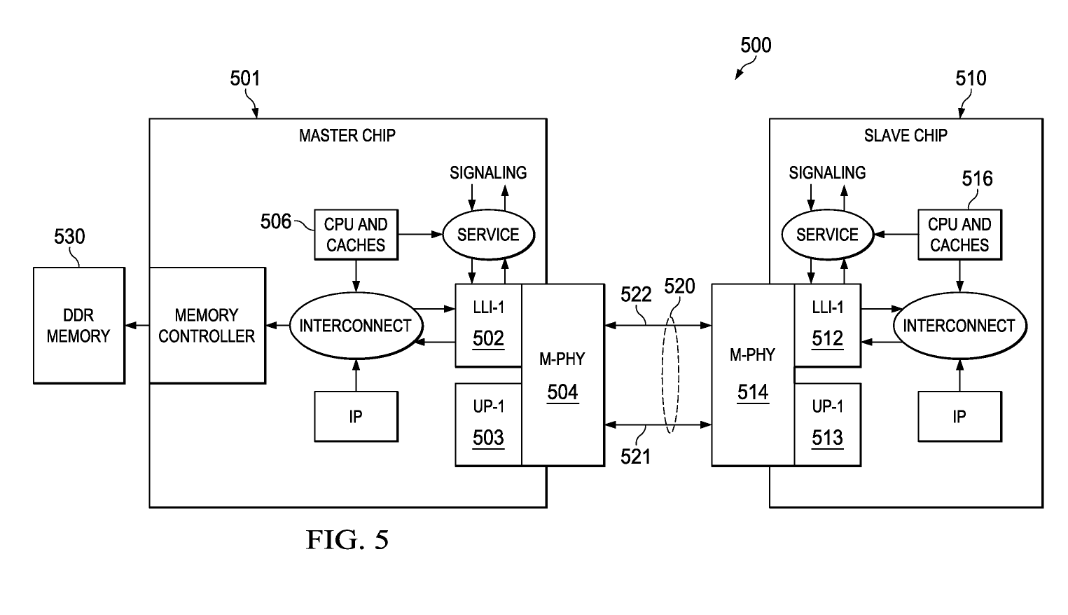

FIG. 5 illustrates an example system 500 with two integrated circuits 501, 510 coupled with configurable M-PHY links 521, 522. IC 501 includes LLI controller 502 and UniPro controller 503 that are coupled to configurable M-PHY interconnect 504. Similarly, IC 510 includes LLI controller 512 and UniPro controller 513 that are coupled to configurable M-PHY interconnect 514. In this example, configurable M-PHY interconnect 504 is controlled by software executed on CPU 506, while configurable M-PHY interconnect 514 is controlled by software executed on CPU 516.

A fixed set of lanes 522 are coupled between the input/output pins on IC 501 and IC 510 that couple to M-PHY interconnect 504 and 514. From this fixed set of lanes, a selectable number of lanes may be allocated to M-PHY link 521 and 522. As described above, the number of lanes allocated to each M-PHY link 521, 522 may be dynamically configured at power up and later during operation of system 500 to optimize performance of ICs 501, 510. In this example, LLI controllers 502 and 512 and M-PHY link 522 allow CPU 516 on IC 510 to access DDR (dual data rate) memory 530 that is coupled to IC 501 just as if DDR memory 530 was coupled directly to IC 510. UniPro controllers 503 and 513 and M-PHY link 521 may be used for other types of communication between IC 501 and IC 510.

In the example of system 500, IC 501 is the System Master, and IC 510 the System Slave. Devices on the Master Chip and the Slave Chip attached to LLI Link 522 are memory-mapped for easy device addressing. The Master Chip controls the Slave Chip and manages the overall system memory map. Thus, the Master Chip sees devices on the Slave Chip as if they are attached to its own interconnect. A LLI resource appears as a device on both the Master Chip interconnect and the Slave Chip interconnect. The control of the local and remote LLI resource are similar to control of a resource connected to the local interconnect, simplifying system design. Configuration, boot interface and management of the physical layer, e.g. M-PHYSM GEAR change, M-PHY power mode, etc., are part of the system software (drivers) and may be implemented in conformance with MIPI standards.

The system on master chip 501 may control the power management of the LLI resources located on slave chip 510 thanks to service transactions. The system also controls power management of the local LLI resources. Service transactions may also used to transfer signal values between the two chips.

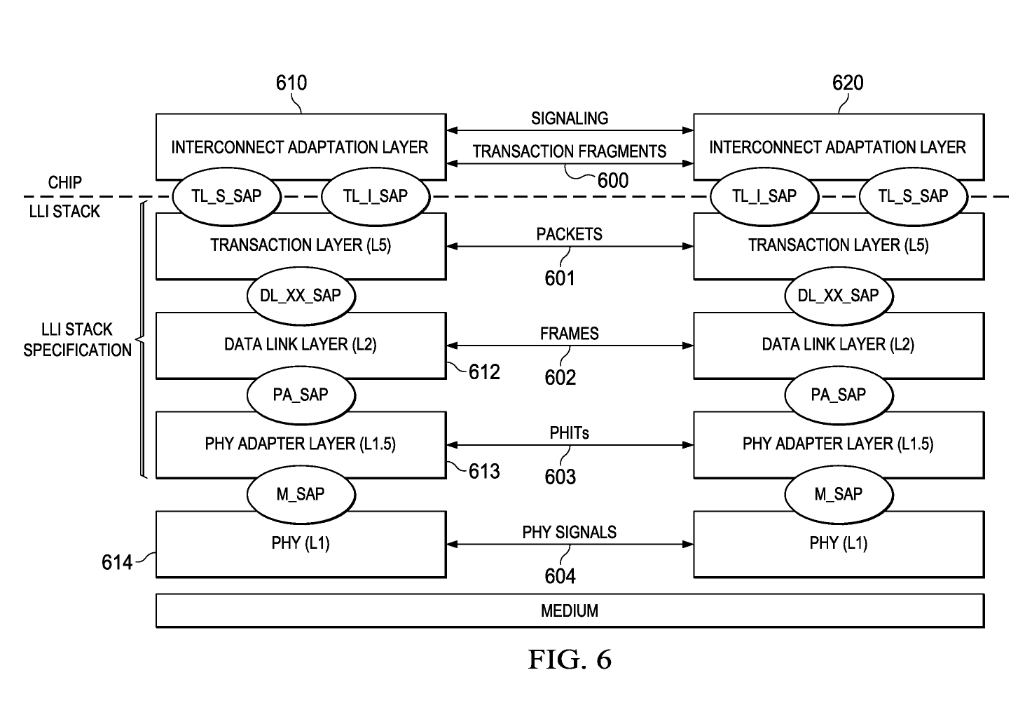

FIG. 6 illustrates a stack protocol for LLI controllers. The protocol will be described briefly in order to illustrate how a configurable M-PHY link may be easily used by a controller. LLI is a layered, transaction-level protocol, where targets and initiators communicate using transaction fragments 600. Each layer in the stack has specific responsibilities and protocol data units (PDUs) that are used to communicate with a peer layer at the other end of the LLI Link. For example, at the top of the stack, the Interconnect Adaptation Layer 610 on one end of the LLI Link communicates with the Interconnect Adaptation Layer 620 on the other end using PDUs called Transaction Fragments. Lower level layers communicate using Packets 601, Frames 602, PHITs (PHY adaptor layer PDU) 603 and, finally, at the lowest level, the PHY Layer, PHY Symbols 604. The layers in the LLI model are conceptual; they are not intended to represent actual implementation.

A LLI stack receives a Transaction Fragment from the local interconnect and converts it to an appropriate PHIT for transmission by the physical layer (PHY) to the remote chip. The PHY Layer converts the PHIT to PHY Symbols and sends the Symbols to the remote chip. A LLI stack receives one or more PHITs from the remote chip, via the local PHY Layer, and converts them into the original Transaction Fragment that is then executed by the Target on the local interconnect. Transaction Fragments are passed to and from the local interconnect using service access points (SAPs). A SAP provides service primitives to transfer Transaction Fragments to, or from, the LLI stack. Since transactions with the remote device can take longer to execute than transactions with local devices, a SAP also provides service primitives to communicate transaction status. A LLI stack can also communicate with devices using signals. Signals are individual signal lines that are converted by the Interconnect Adaptation Layer to Transaction Fragments that are then passed to the remote LLI stack in the same manner as if the Transaction Fragments were received through a SAP. At the remote LLI stack, the Transaction Fragments are converted back to signals.

The Interconnect Adaptation Layer is responsible for adapting the LLI Transaction Layer to a transaction-based interconnect that manages communications inside a chip. An interconnect transaction is typically composed of one or more read or write request transfer cycles, optional write data transfer cycles, and zero or more response transfer cycles. From the Interconnect Adaptation Layer point of view, a LLI Transaction is composed of a LLI Request Unit and a LLI Response Unit, each of which is composed of one or more LLI Fragments. Where the LLI Link acts as a target of the interconnect (LLI Target SAP), the Interconnect Adaptation Layer maps interconnect request and write data transfer cycles to LLI Fragments forming one or more LLI Request Units, and also maps the associated returned LLI Fragments forming the LLI Response Units to the proper response transfer cycles according to the interconnect protocol. In general, a single LLI transaction, i.e., a single pair of LLI Transaction Request and Response Units, is all that is needed for a given interconnect transaction, but in some cases several such pairs might be necessary. For example, if the interconnect transaction has a length greater than the maximum LLI Transaction length, the interconnect transaction must be split by the Interconnect Adaptation Layer into several LLI Request Units and associated Response Units, each of which is composed of its LLI Fragments. It is then the responsibility of the Interconnect Adaptation Layer to process and merge the LLI Response Units to create the appropriate interconnect response transfer cycles for the single interconnect transaction. After being transported through the local LLI stack, LLI Transaction Fragments constituting Request Units reach the remote LLI stack on a LLI Initiator SAP where the remote Interconnect Adaptation Layer converts them to interconnect request and write data transfer cycles. Note that the local interconnect protocol might differ from the remote interconnect protocol, so that the interconnect transfer cycles usually differ between the local and remote sides of the LLI Link. At an LLI Initiator SAP, the Interconnect Adaptation Layer also maps interconnect response transfer cycles to LLI Transaction Fragments constituting a LLI Response Unit corresponding to the associated LLI Request Unit. These LLI Transaction Fragments are transported back through the LLI stack to the target SAP that originated the LLI Transaction; where the Interconnect Adaptation Layer converts them into the appropriate interconnect response transfer cycles.

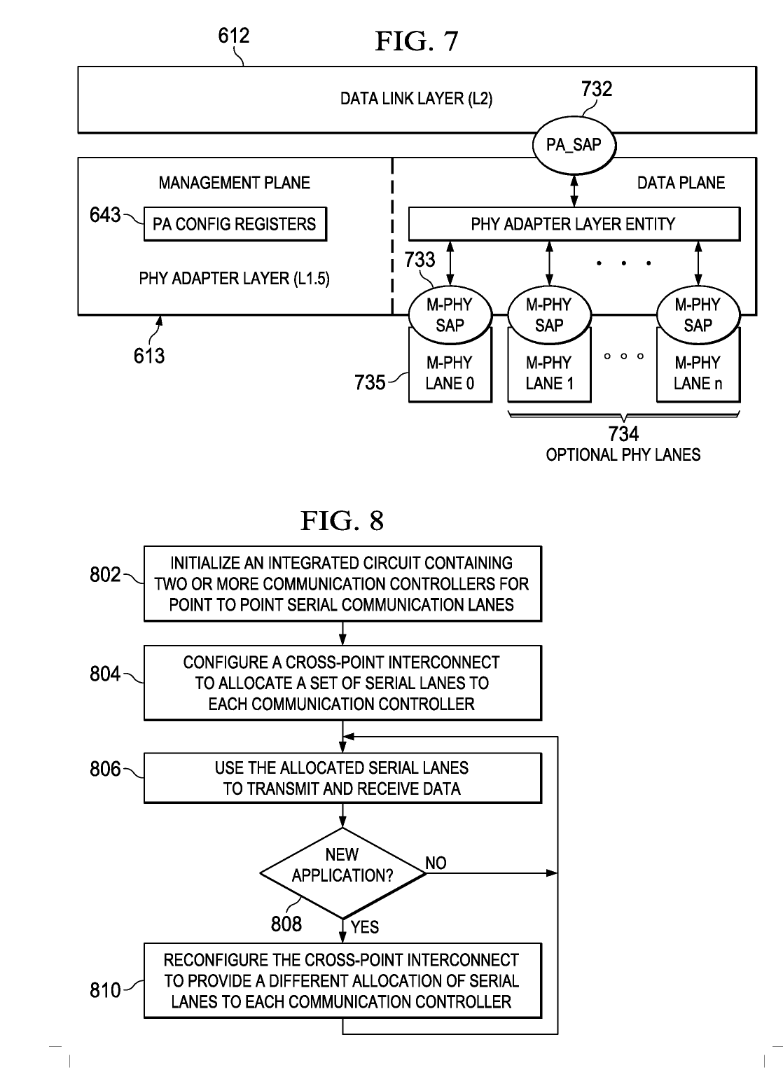

FIG. 7 illustrates the PHY adaptor layer 613 and PHY layer 614 of an LLI protocol stack. The PHY Adapter Layer serves as an intermediate layer between one or more LANEs of the M-PHY. Service to the Data Link Layer 612 is provided by means of the PHY Adapter Service Access Point (PA SAP) 732. The PHY Adapter Layer 613 in turn relies on the service provided by the M-PHY Service Access Points (M-PHY SAPs) 733. The PHY Adapter Layer control and configuration is done by accessing PA Config Registers 643, which are a subset of LLI configuration attribute space. The PHY Adapter Layer ensures that the upper layers of the LLI stack are decoupled from the PHY technology by abstracting internal implementation details of the PHY Layer from the Data Link Layer.

A detailed description of an LLI controller requirement is provided in the “MIPI Alliance Specification for Low Latency Interface (LLI),” which is available from the MIPI Alliance.

As described in more detail above, embodiments of the invention allow the number of M-PHY lanes allocated to a particular LLI protocol to be dynamically configured based on what application is being executed in a system. For example, a single lane 735 may be allocated for low performance needs, while additional lanes 734 may be allocated to an LLI controller to provide a higher level of communication performance. The number of lanes that are recognized by the LLI protocol stack is controlled by PA configuration registers 643.

In a similar manner, a UniPro protocol stack or other defined communication protocols may be dynamically configured to respond to a dynamically configured number of M-PHY lanes that are allocated to a controller for that protocol.

FIG. 8 is a flow chart illustrating operation of a configurable M-PHY interface in a system that includes two or more integrated circuits with a set of point to point serial communication lanes coupled between the integrated circuits. As described in more detail above, the ICs may include a cross-point switch that is coupled between a set of communication controllers and a set of serial communication lanes that drive and receive data from external pins on the IC.

The system is turned on and each of the integrated circuits is initialized 802. Typically, an integrated circuit may be initialized by executing a boot program that is stored in non-volatile memory by a CPU within the integrated circuit. The cross-point switch may be initialized to a default configuration by a power-on reset signal. After completing the boot procedure, or as part of the boot procedure, a program may be executed that may further configure 804 the cross-point switch circuit within the IC. A configuration program being executed by a CPU in one of the ICs may send commands via the serial links to reconfigure cross-point switches on other ICs in the system, for example.

As described above in more detail, the cross-point switch is coupled between a set of communication controllers and a set of serial communication lane ports that drive and receive data from external pins on the IC. The cross-point switch is configured to allocate 804 a first portion of the set of point to point serial communication lane ports for use by one of the communication controllers in the IC and a second portion of the set of point to point serial communication lane ports for use by a second communication controller in the IC. If there are more than two communication controllers in the IC, portions of the set of point to point serial communication lanes may be allocated to them also.

Once the cross-point switch is configured, an application program being executed in the system may transmit and receive data 806 via the first communication controller using the first portion of serial communication lanes and via the second communication controller using the second portion of serial communication lanes.

At some point in time, a different application program may be executed 808. The cross-point switch may be reconfigured 810 to couple a different number of transmit lanes and/or receive lanes to some or all of the communication controllers. Once the cross-point switch is reconfigured, the different application program being executed in the system may transmit and receive data 806 via the first communication controller using the new allocation of serial communication lanes and via the second communication controller using the new allocation of serial communication lanes.

Different application programs may also configure a particular communication controller to use different protocols at different times. For example, a controller may communicate using an LLI protocol for a period of time, and then communicated using a UniPort, or other type of protocol for another period of time. The number of serial lanes allocated to the controller may be adjusted based on what protocol is being used at the time.

The serial communication lanes may be a set of M-PHY lanes, or may be a set of D-PHY lanes, for example. In another embodiment, other types of serial point to point communication lanes may be used, such a PCI Express lanes, for example.

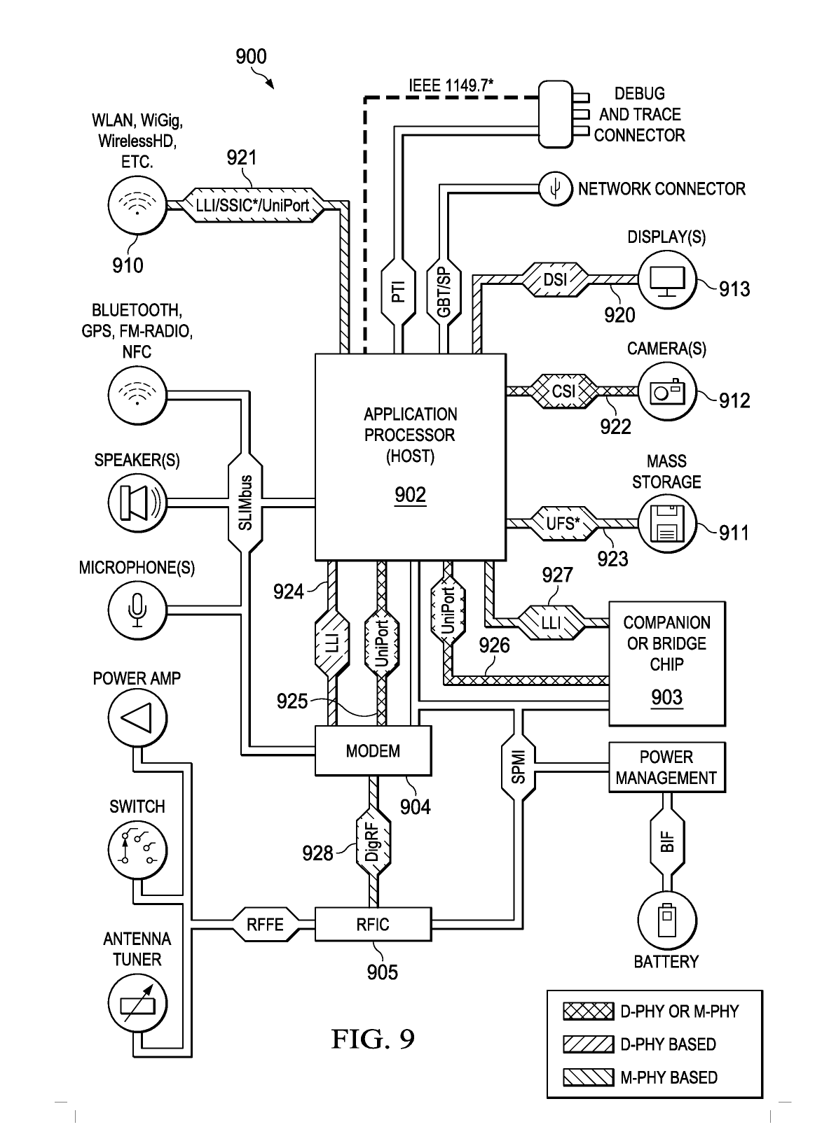

FIG. 9 is a block diagram illustrating an example system 900 with point to point serial interconnects, including D-PHY and M-PHY interconnects. In this example, system 900 is a smart phone that includes a camera 912, mass storage 911, short range wireless interfaces 910, and display 913 that are all coupled to an application processor IC 902 via point to point serial links 920-923. In this example, serial link 920 is a D-PHY link, while serial links 921-923 are M-PHY links. The general operation of smart phones is well known as will not be described further herein.

IC 902 is coupled to modem IC 904 that performs audio signal conversion and radio frequency signal conversion. IC 902 is coupled to modem IC 904 via LLI link 924 and UniPro link 925. IC 902 is coupled to bridge IC 903 via LLI link 927 and UniPro link 926. Modem IC 903 is coupled to radio frequency transceiver IC 905 via DigRF link 928.

All of the M-PHY links 921-928 contain a number of serial transmit and receive lanes, as described in more detail above. Application processor IC 902 includes a cross-point switch as described in more detail above that allows the number of serial lanes allocated to each link 921-927 to be configured when the smart phone is powered on. This allows IC 902 to be used in system 900 with a selected number of lanes allocated to links 921-927, but allows the same version of IC 902 to be used in a different system in which a different allocation of links may be needed. In this manner, a single version of IC 902 may be manufactured and then the serial communication lanes may be configured as needed for different system implementations.

### OTHER EMBODIMENTS

While the invention has been described with reference to illustrative embodiments, this description is not intended to be construed in a limiting sense. Various other embodiments of the invention will be apparent to persons skilled in the art upon reference to this description. For example, embodiments of the invention may include smart phones, laptop computers, computer tablets, and all manner of portable computing systems in which the same version of an integrated circuit may be used in different products and configured when the product is turned on to allocate pins on the integrated circuit that provide serial communication lanes to different combinations of communication links on each of the different products. Likewise, embodiments of the invention may included personal computers, mainframe computers and all manner of fixed computing systems in which the same version of an integrated circuit may be used in different systems or in different portions of a same system and configured when the system is turned on to allocate pins on the integrated circuit that provide serial communication lanes to different combinations of communication links on each of the different systems.

While embodiments of the invention have been described with reference to LLI, UniPro, CSI, etc, SerDes (serializer-deserializer) interfaces, other embodiments may include other types of SerDes interfaces that are now known or later developed.

While embodiments of the invention have been described with reference to M-PHY physical lanes, other embodiments may use D-PHY lanes, PCIe lanes, or other physical types of serial communication channels now known or later developed.

In some embodiments, the multiplexor and demultiplexor may function as a complete cross-point switch and allow any transmit lane to be coupled to any physical adaptor transmit lane terminal and allow receive lane to be coupled to any physical adaptor receive lane terminal. In other embodiments, timing restrictions may limit the cross-point interconnect capability to a subset of all possible connections.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., disk, optical disk, flash memory, USB key), via a transmission path from computer readable media on another digital system, etc.

Certain terms are used throughout the description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope and spirit of the invention.

What is claimed is:

1. A digital system comprising an integrated circuit, wherein the integrated circuit comprises:
a plurality of serial transmit lane drivers coupled to pins of the integrated circuit (IC);
a plurality of serial receive lane receivers coupled to pins of the IC;
a plurality of communication controllers each having a physical adaptor wherein each physical adaptor has a plurality of serial lane terminals, wherein a portion of the serial lane terminals are for transmitting and a portion of the serial lane terminals are for receiving;
a programmable multiplexor coupled between the plurality of transmit lane drivers and the plurality of transmit lane terminals on the plurality of communication controllers;
a programmable demultiplexor coupled between the plurality of receive lane receivers and the plurality of receive lane terminals on the plurality of communication controllers; and
a control module coupled to the multiplexor and to the demultiplexor, wherein the control module is operable to program the multiplexor to couple each transmit lane terminal to a selected one of the plurality of transmit lane drivers, and to program the demultiplexor to couple each receive lane terminal to a selected one of the plurality of receive lane receivers.

2. The digital system of claim 1, wherein the plurality of transmit lanes and the plurality of receive lanes are M-PHY lanes.

3. The digital system of claim 1, wherein one of the plurality of communication controllers is operable to use a portion of its transmit link terminals for a first application, and a different portion of it's transmit link terminals for a second application.

4. The digital system of claim 1, wherein the control module is operable to program the multiplexor and the demultiplexor to couple a first set of serial transmit lane drivers and serial receive lane receivers to the lane terminals of a first communication controller of the plurality of communication controllers for a first period of time and to couple a different set of serial transmit lane drivers and serial receive lane receivers to the lane terminals of the first communication controller for a second period of time.

5. The digital system of claim 1, wherein the control module is operable to program the multiplexor to couple a number of serial transmit lane drivers to the lane terminals of a first communication controller of the plurality of communication controllers and to program the demultiplexor to couple a different number of serial receive lane receivers to the lane terminals of the first communication controller.

6. The digital system of claim 1 being a smart phone, wherein the digital system comprises a second integrated circuit coupled to the IC via a plurality of transmission lines coupled to the pins of the IC that are coupled to the receive lane receivers and to the transmit lane drivers.

7. A method for operating a system having an integrated circuit coupled to a plurality of point to point serial communication lanes for communication with other integrated circuits, wherein the method comprises:
initializing the integrated circuit when the integrated circuit is powered on;
configuring a cross-point interconnect circuit to allocate a first portion of the plurality of point to point serial communication lanes for use by a first communication controller in the integrated circuit and a second portion of the plurality of point to point serial communication lanes for use by a second communication controller in the integrated circuit; and
transmitting and receiving data via the first communication controller using the first portion of serial communication lanes and via the second communication controller using the second portion of serial communication lanes.

8. The method of claim 7, wherein the plurality of point to point serial communication lanes comprise transmit lanes and receive lanes, and wherein the cross-point interconnect circuit is configured to allocate the first portion to have a number of transmit lanes and a different number of receive lanes.

9. The method of claim 7, wherein configuring the cross-point interconnect circuit is performed by software instructions executed by a central processing unit (CPU) within the integrated circuit.

10. The method of claim 7, wherein the plurality of communication lanes are M-PHY lanes.

11. The method of claim 7, further comprising reconfiguring the cross-point circuit to allocate a third portion of the plurality of point to point serial communication lanes for use by the first communication controller and a fourth portion of the plurality of point to point serial communication lanes for use by the second communication controller; and
transmitting and receiving data via the first communication controller using the third portion of serial communication lanes and via the second communication controller using the fourth portion of serial communication lanes.

12. The method of claim 11, wherein transmitting and receiving data via the first communication controller using the first portion of serial communication lanes and via the second communication controller using the second portion of serial communication lanes is performed for a first period of time, and
wherein transmitting and receiving data via the first communication controller using the third portion of serial communication lanes and via the second communication controller using the fourth portion of serial communication lanes is performed for a second period of time.

13. A digital system comprising an integrated circuit, wherein the integrated circuit comprises:
a plurality of serial transmit lane drivers coupled to pins of the integrated circuit (IC);
a plurality of serial receive lane receivers coupled to pins of the IC;
a plurality of communication controllers each having a physical adaptor wherein each physical adaptor has a plurality of serial lane terminals, wherein a portion of the serial lane terminals are for transmitting and a portion of the serial lane terminals are for receiving;
means for initializing the integrated after a power reset; and
means for allocating a first portion of the plurality of serial transmit lane drivers and serial receive lane receivers for use by a first one of the plurality of communication controller and a second portion of the plurality of serial transmit lane drivers and serial receive lane receivers for use by a second one of the plurality of communication controllers.

14. The digital system of claim 13, further comprising:
means for reallocating at a different time a third portion of the plurality of serial transmit lane drivers and serial receive lane receivers for use by the first communication controller and a fourth portion of the plurality of point to point serial transmit lane drivers and serial receive lane receivers for use by the second communication controller.

15. The digital system of claim 13, wherein the means for allocating is operable to allocate a number of serial transmit lane drivers to the lane terminals of a first communication controller of the plurality of communication controllers and allocate a different number of serial receive lane receivers to the lane terminals of the first communication controller.
